(19) United States
(12) Patent Application Publication
(10) Pub. No.: US 2006/0095655 A1
(43) Pub. Date: May 4, 2006

(54) Synchronous interface and method of operation

(76) Inventors: George S. Moore, Veradale, WA (US); Timothy K. Christensen, Otis Orchards, WA (US); Brian K. Okken, Liberty Lake, WA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/981,043

(22) Filed: Nov. 4, 2004

(51) Int. Cl. G06F 12/14

(52) U.S. Cl. 711/109

(57) ABSTRACT

In one embodiment, an interface facilitates communication of data between a source block and a sink block. The interface comprises a first register element that receives data from the source block via an input line, wherein the first register element changes value when a clock enable signal is applied to the first register element and maintains its value when the clock enable signal is not applied; a first multiplexer coupled to the input line and an output of the first register element; and a first shift register for receiving a signal from the sink block indicating that the sink block is retrieving data from the interface; wherein the first shift register outputs a delayed version of the signal from the sink block to provide the clock enable signal to the first register element and to control an output of the first multiplexer.

### TECHNICAL FIELD

The present application is generally related to an interface for communicating data between logic blocks.

### BACKGROUND

When designing electronic devices, data is typically communicated between respective logic devices of a device. However, the timing of the operation of the various devices may vary thereby complicating the exchange of data. Accordingly, it is frequently desirable to provide an interface between logic devices to facilitate data communication.

FIG. 1 depicts a conventional system using first in, first out (FIFO) interface 101 disposed between digital-to-analog converter (DAC) 102 and memory 103. DAC 102 operates, in real time, and receives digital samples from FIFO 101 at frequency Fₒ. FIFO 101 provides a signal to memory 103 whenever FIFO 101 is not full and, in response, memory 103 provides data to FIFO 101. Accordingly, FIFO 101 “pulls” data from memory 103. Also, memory 103 operates at a frequency of Fₘ which is greater or equal to Fₒ. Accordingly, data is always available in FIFO 101 for provision to DAC 102. Although the use of FIFO interfaces in this manner operates reasonably well, FIFO interfaces possess limitations. In particular, FIFO interfaces require circuit designs to include greater complexity than desired and also impose a degree of latency.

### SUMMARY

Some representative embodiments are directed to an interface for communicating data between logic blocks and a method of operation. In some representative embodiments, data is communicated according to “data pull” flow control. Specifically, a pull signal is asserted upon the retrieval of data to indicate that additional data should be made available upon the next clock cycle. In some representative embodiments, one or several delay elements are used by the interface to delay the assertion of a pull signal by a “sink” block from the assertion of a pull signal by the interface to a “source” block. Additionally, in some representative embodiments, one or several register elements are used to hold data until the next assertion of the pull signal by the sink block. A multiplexer is used to control the output from the register elements to the sink block. In alternative embodiments, a look-up table or suitable combinatorial logic is used to control the multiplexer using the history of pull signal assertions by the sink block.

By using the delayed assertions of the pull signal in this manner, data may pass directly from the source block to the sink block when the pull signal is continuously asserted. Also, when the pull signal transitions from being asserted to not being asserted, the delay ensures that a data element from the source will be immediately available upon the next assertion of the pull signal. Specifically, the delayed pull signal causes an additional data element to be obtained from the source block and stored in a register element until the next assertion of the pull signal. Accordingly, the delay of the pull signal in conjunction with the operation of the multiplexer enables data pull flow control to occur in a cascaded manner between multiple logic blocks without restricting the frequencies of the respective pull signals. Additionally, the physical implementation of interfaces may involve substantially less complexity and latency than traditional FIFO interfaces.

### BRIEF DESCRIPTION OF THE DRAWINGS

FIG. 1 depicts a system having a traditional FIFO interface.

FIG. 2 depicts a timing diagram of data pull flow control.

FIG. 3 depicts a system that employs data pull flow control.

FIG. 4 depicts a register element that may be employed within interfaces according to some representative embodiments.

FIG. 5 depicts an interface according to one representative embodiment.

FIG. 6 depicts a timing diagram associated with the interface shown in FIG. 5.

FIGS. 7 and 8 depict interfaces according to alternative embodiments.

FIG. 9 depicts values for a look-up table for the interface shown in FIG. 8 according to one representative embodiment.

FIGS. 10-12 depict ambidextrous interfaces according to alternative embodiments.

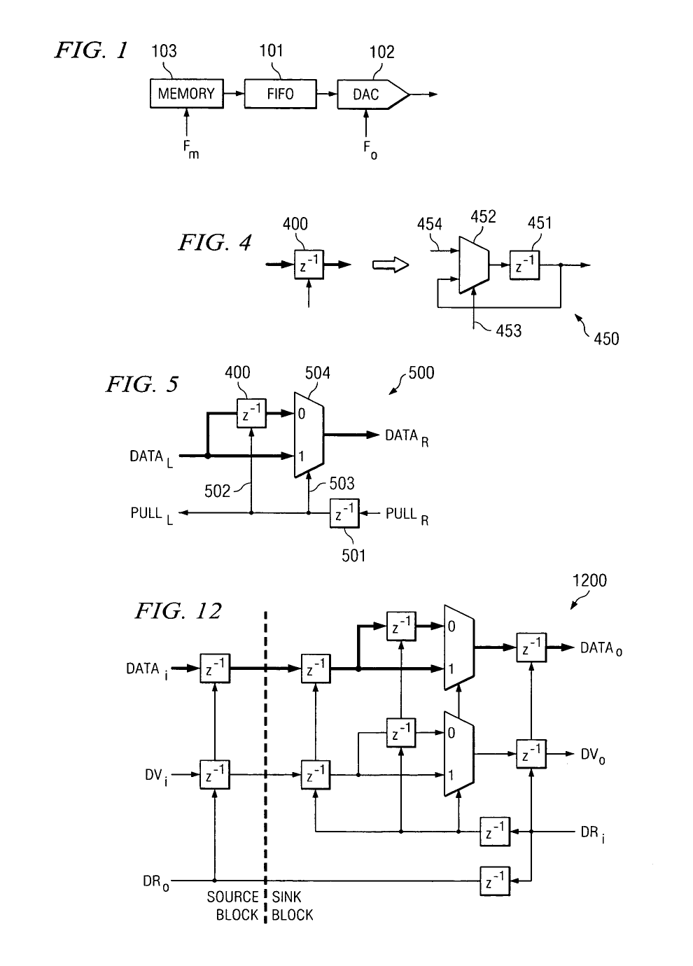

### DETAILED DESCRIPTION

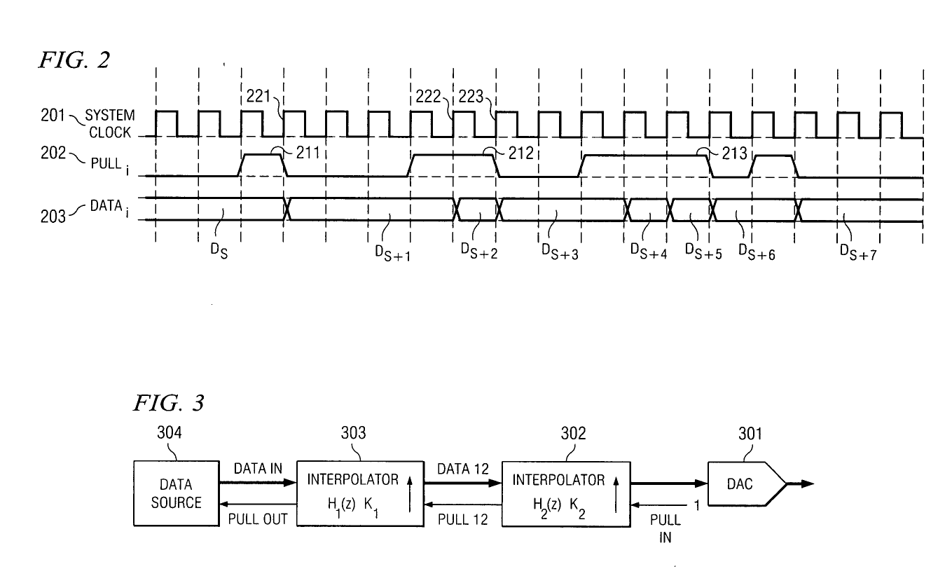

Some representative embodiments are directed to interfaces that are compliant with a data pull flow control method. To illustrate an example of data pull flow control, reference is made to FIG. 2. The operation of data pull flow control occurs using system clock 201. A pull assertion signal 202 (denoted by Pullᵢ) signifies that data 203 present on the data line(s) will be taken on the next rising edge and new data is to be made available for the next data pull assertion.

Initially, data Dₛ is present on the data line. Pull assertion 211 only lasts one clock cycle and, accordingly, only one data element is taken. Specifically, pull assertion 211 occurs to obtain the data from the data line at rising edge 221 thereby causing data Dₛ to be replaced by data Dₛ₊₁. Pull assertion 212 lasts two clock cycles and causes data Dₛ₊₁ and Dₛ₊₂ to be taken at rising edges 222 and 223, respectively. Likewise, pull assertion 213 lasts three clock cycles and causes data Dₛ₊₃ through Dₛ₊₅ to be taken.

FIG. 3 depicts system 300 that employs data pull flow control in a cascaded manner. Data originates from data source 304 and is processed by interpolators 302 and 303. The interpolated data is provided to DAC 301 to generate an analog signal. DAC 301 is the final data sink in system 300, i.e., no further propagation of the digital data occurs after DAC 301. DAC 301 provides a pull assertion signal (denoted by Pull In) according to the system clock that operates at frequency F_{S}. Interpolator 302 generates K₂ output samples for every input sample. Interpolator 302 provides a pull assertion signal (denoted by Pull 12) every K₂ clock cycles to interpolator 303. Interpolator 303 generates K₁ output samples for every input sample. Interpolator 303 provides a pull assertion signal (denoted by Pull Out) every K₁*K₂ clock cycles to data source 304.

As seen in FIG. 3, the data pull flow control is complicated by the fact that the control signals propagate in the opposite direction as the data signals. Depending upon the state of the data flow, it is possible that a pull signal initiated from DAC 301 would need to be propagated to data source 304 within a single clock cycle. The ability to propagate the signal to the original source block may not be possible depending upon circuit complexity (especially if multiple logic blocks are cascaded). Additionally, if K_{1 or K}₂ is not an integer (e.g., rational resampling is performed), the combinatorial relationships between the pull signals of the various logic devices can be complex.

FIG. 4 depicts a notational convention that is used to reduce the complexity of other FIGURES of interfaces adapted according to some representative embodiments. Register element 400 depicts a register (denoted by z⁻¹) with two “heavy” lines used to communicate data and one “lighter” line that is associated with a clock enable signal. In operation, register element 400 retains its stored value when the clock enable signal is not present and changes its stored value when the clock enable signal is present. Corresponding structure 450 represents a physical implementation of the operation of register element 400. Corresponding structure 450 includes multiplexer 452 coupled to input data line 454 and coupled to the output of register 451. The output of multiplexer 452 is controlled by the signal present on line 453. When the signal is high, multiplexer 452 outputs the data received via line 454. When the signal is low, multiplexer 452 outputs the data received from the output of register 451 thereby feeding back the data to register 451.

FIG. 5 depicts synchronous interface 500 adapted for data pull flow control according to one representative embodiment. Interface 500 receives data from a prior logic block (not shown) and provides data to a subsequent logic block (not shown). When the subsequent logic block retrieves data (Data_{R}), the subsequent logic block asserts the Pull_{R} signal to request that the next data element be made available at the next clock cycle. Interface 500 retrieves the data elements from the prior logic block using the Data_{L} line. Interface 500 asserts the Pull_{L} signal when it retrieves data to ensure that the next data element is available at the next clock cycle.

Interface 500 comprises shift register 501 to provide a delay between the assertion of the Pull_{R} signal and the assertion of the Pull_{L} signal. Additionally, the delayed pull signal is used to control register element 400 and multiplexer 504 via lines 502 and 503 respectively. By using the delayed pull signal in this manner, interface 500 is operable to enable data elements to pass directly from the prior logic block to the subsequent block when the Pull_{R} signal is continuously asserted. Also, when the Pull_{R} signal transitions from being asserted to not being asserted, the delay ensures that a data element from the prior subsequent block will be immediately available upon the next assertion of the Pull_{R} signal. Specifically, the delayed pull signal causes an additional data element to be obtained from the prior logic block and stored in register element 400 until the next assertion of the Pull_{R} signal. Accordingly, the delay of the pull signal in conjunction with the operation of multiplexer 504 and register element 400 enables data pull flow control to occur in a cascaded manner without restricting the frequencies of the respective pull signals.

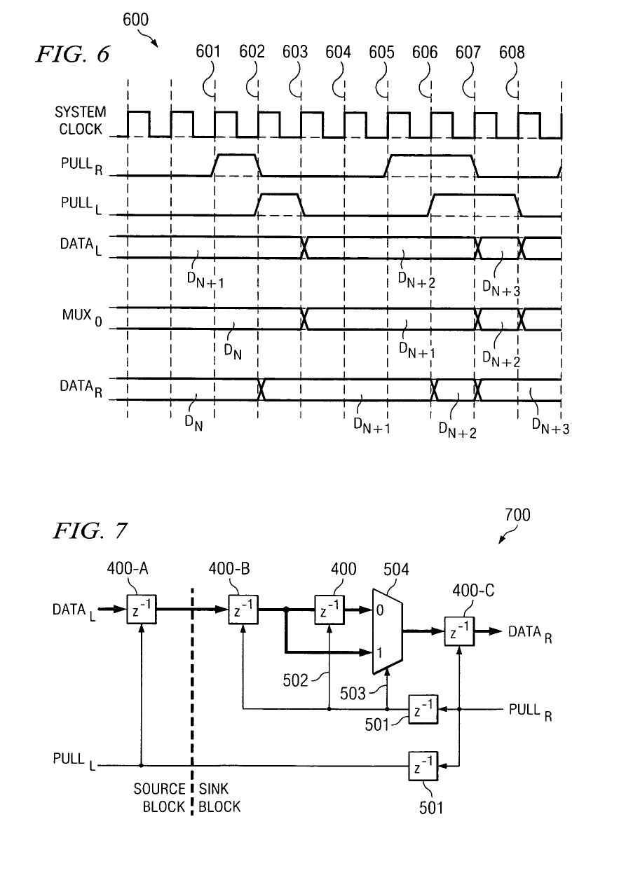

FIG. 6 depicts timing diagram 600 associated with the operation of interface 500. Timing diagram 600 illustrates the system clock, the Pull_{R} signal, the Pull_{L} signal, the Data_{L} signal, the output of register element 400 which is provided to the first input (MUX₀) of multiplexer 504, and the Data_{R} signal. Initially, the respective pull signals are not asserted. The Data_{R} signal and the MUX₀ signal have a value of D_{N}. The Data_{L} signal has a value of D_{N+1} as provided from the block prior to interface 500.

The Pull_{R} signal is initially asserted at time 601 and, hence, the logic block that is subsequent to interface 500 retrieves data element D_{N}. The Pull_{L} signal is then asserted at the next clock cycle (time 602) due to the delay provided by shift register 501. At that time, multiplexer 504 outputs the value (D_{N+1}) present on its other input (MUX₁) which is the Data_{L} signal. Specifically, control line 503 of multiplexer 504 receives the delayed pull signal thereby causing multiplexer 504 to output the value of its second input line. Accordingly, the Data_{R} signal changes value to D_{N+1}. At time 602, the value of register element 400 changes to the value (D_{N+1}) of the Data_{L} signal, because its clock enable signal is the delayed pull signal. Also, at time 602, the Pull_{R} signal is no longer asserted.

At time 603, the block preceding interface 500 makes the next data element available (the Data_{L} signal changes to value D_{N+2}). Due to the delay provided by shift register 501, the Pull_{R} signal is not asserted. Also, due to the delay provided by shift register 501, multiplexer 504 switches to its first input (MUX₀) which is received from register element 400. Register element 400 outputs the value received in the previous cycle (D_{N+2}). Also, because the clock enable signal is no longer provided to register element 400, register element 400 maintains its value and, hence, the Data_{L} signal remains at a value of D_{N+2}.

The effect of multiple cycle assertions of the Pull_{R} signal can been seen in reference of times 605-608. Interface 500 operates in substantially the same manner as previously described, except, upon the repetition of the assertion of the Pull_{R} signal, multiplexer 504 allows data to flow directly from the prior block to the subsequent block.

As shown in FIG. 7, interface 700 operates according to data pull flow control according to another embodiment. Interface 700 operates in substantially the same manner as interface 500 except interface 700 comprises register elements 400-A, 400-B, and 400-C. Interface 700 addresses the additional delay through the multiplexer, eliminates phantom transitions, and unloads the output pull register. Although interface 700 does not satisfy a strict “registered-in, registered-out” requirement (the pull signal gates the source register), interface 700 is suitable for most internal applications (e.g., with an ASIC or FPGA).

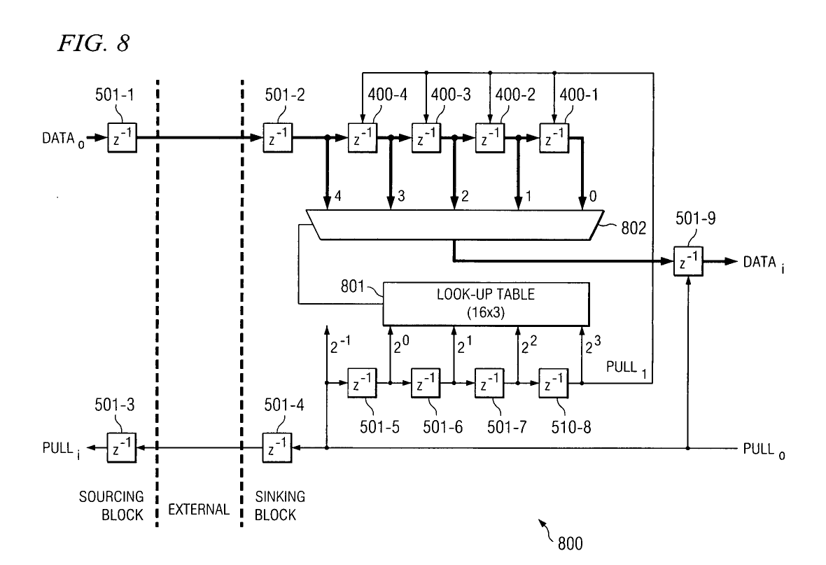

Interface 800 (as shown in FIG. 8) performs registered-in, registered-out operations and is suitable for synchronously clocked interfaces according to another representative embodiment. Interface 800 comprises shift register 501-1 to register-out data from the source block to the sink block. Also, interface 800 comprises shift register 501-3 to register-in the pull signals from the sink block to the source block. Interface 800 further comprises registers 501-2 and 501-4 on the sink block side that correspond to registers 501-1 and 501-3. Additionally, interface 800 comprises register 501-9 to store the data before additional processing by the sink block.

Because of shift registers 501-1 through 501-4, there is a four clock cycle delay before the assertion of the Pullₒ signal and the availability of new data. Interface 800 comprises register elements 400-1 through 400-4, shift registers 501-5 through 501-8, look-up table 801, and multiplexer 802 to address the four cycles of delay. Register elements 400-1 through 400-4 enable four data elements to be stored between disjoint assertions of the Pullₒ signal to enable a data element to be immediately available when needed.

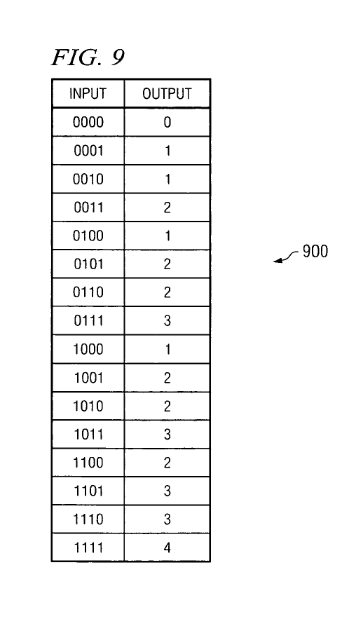

Depending upon the pattern of assertions of the Pullₒ signal, different patterns of register elements 400 will have valid data. For example, if the Pullₒ signal has been continuously asserted for a long time, only the output of shift register 501-2 will be associated with valid data. Alternatively, if the Pullₒ signal has not been asserted for a long time, all of registers elements 400-1 through 400-4 will have valid data. Shift registers 501-5 through 505-8 maintain a history of the recent states of the Pullₒ signal. The outputs of shift registers 501-5 through 505-8 are provided to look-up table 801. The purpose of look-up table 801 is to identify the proper location of data when the Pullₒ signal is asserted. Look-up table 801 may be implemented using table 900 shown in FIG. 9. In one embodiment, the look-up value is defined by the number of assertions of the Pullₒ signal within the past four clock cycles. Other logic designs may be employed to perform the determination if desired. For example, combinatorial logic may be employed. Alternatively, logic 801 may increment, decrement, and maintain a count depending upon the outputs of shift registers 501-5 through 501-8. Specifically, if the left most signal is asserted and the right most signal is not asserted, the count is incremented. If the left most signal is asserted and the right most signal is not asserted, the count is decremented. If both are in the same state, the count is maintained.

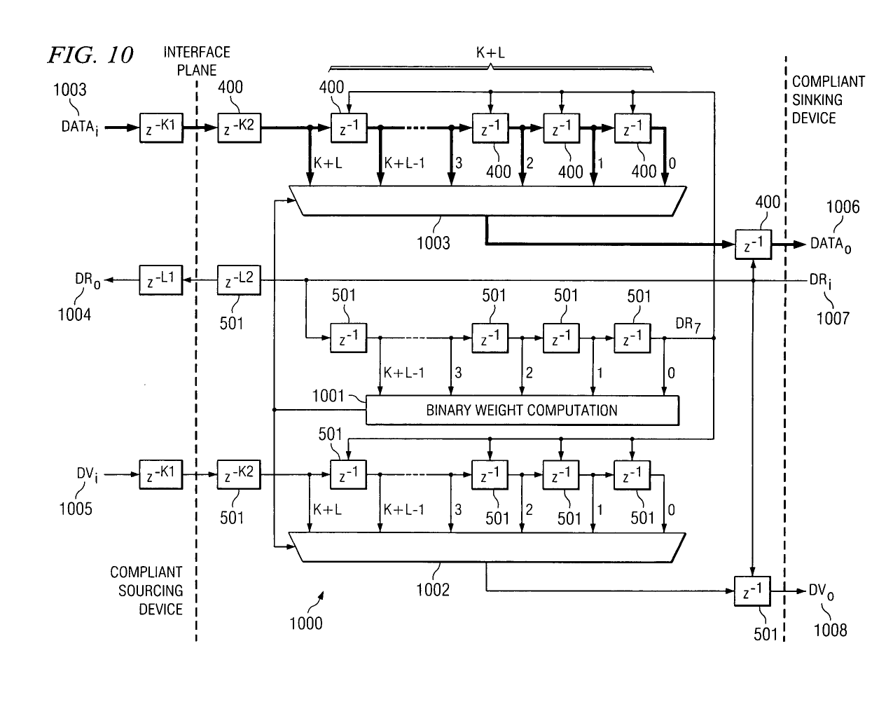

In addition, some representative embodiments may provide an interface for “ambidextrous” interfaces. Ambidextrous interfaces generally refer to interfaces in which data flow control is communicated according to the coincidence of “data valid” signals (data is ready to the communicated) and “data requested” signals (pull signals). Interface 1000 shown in FIG. 10 depicts a general case of ambidextrous data flow control according to one representative embodiment. Dataᵢ 1003 is received from a source block when the source block indicates that it has data available by asserting DVᵢ signal 1005 and when the interface asserts DRₒ signal 1004. Dataₒ 1006 is communicated from interface 1000 to the sink block when interface 1000 indicates that data is available using DVₒ signal 1008 and when the sink block indicates that it is ready for data using DRᵢ signal 1007.

The internal elements of interface 1000 operate in a similar manner to the internal elements of interface 800. Interface 1000 includes a plurality of register elements 400 (K+L) to hold data when appropriate and to enable data to pass through interface 1000 when appropriate. A subset of register elements 400 may be disposed on both sides of the interface plane between the source device and the sink device. Also, a subset of register elements 400 are coupled to multiplexer 1003. A plurality (K+L) of shift registers 501 buffer DRᵢ signals 1007 and a subset of those shift registers 501 are coupled to binary weight computation logic 1001. From the outputs of the subset of shift registers 501, binary weight computation 1001 determines the location of the next valid data element and controls multiplexer 1003 accordingly. Additionally, a plurality (K+L) of shift registers 501 buffer DRᵢ signals 1007 and a subset of shift registers 501 are coupled to multiplexer 1002. Also, binary weight computation 1001 controls multiplexer 1002 to provide values associated with DVₒ signal 1008.

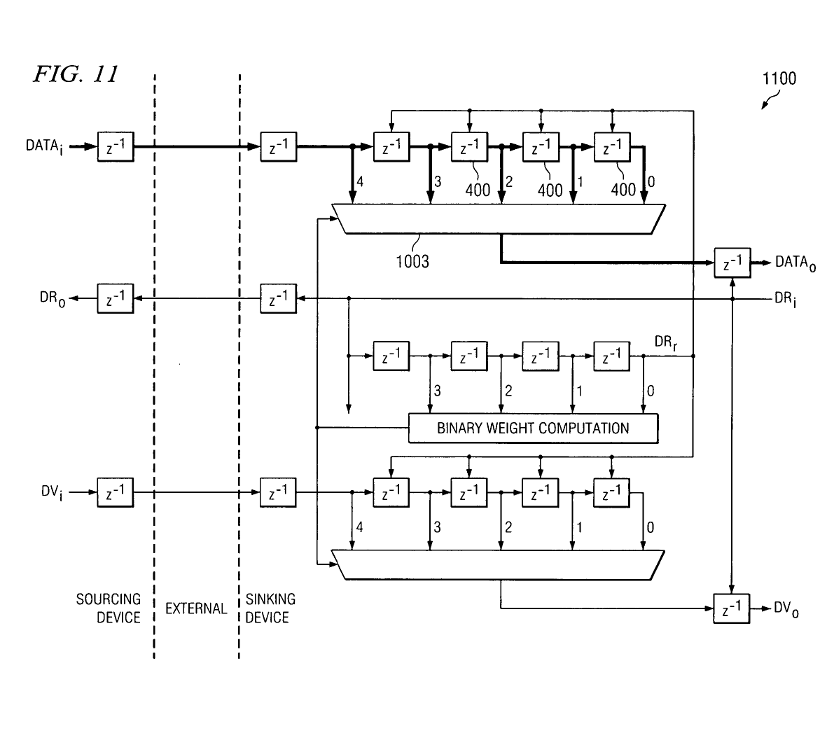

Interface 1000 may be considered a general case from which other interfaces may be derived. Specifically, interfaces 500, 700, 800, 1100 and 1200 are all special cases of interface 1000. Also, FIGS. 11 and 12 depict related ambidextrous interfaces 1100 and 1200 according to some representative embodiments. Ambidextrous interface 1100 is an ambidextrous design that is similar to the registered-in, registered-out design of interface 800. Likewise, ambidextrous interface 1200 is an ambidextrous design that is similar to the design of interface 700.

By implementing interfaces using delayed assertions of pull signals, some representative embodiments may provide a number of advantages. For example, data may continuously pass from a source block to a sink block when the pull signal is continuously asserted. Also, when the pull signal transitions from being asserted to not being asserted, the delay ensures that a data element from the source will be immediately available upon the next assertion of the pull signal. Specifically, the delayed pull signal causes one or several additional data elements to be obtained from the source block and stored in appropriate register element(s) until the next assertion of the pull signal. Also, by suitably controlling a multiplexer coupled to the register elements, data pull flow control may occur in a cascaded manner between multiple logic blocks without restricting the frequencies of the respective pull signals. Additionally, the physical implementation of interfaces may involve substantially less complexity and latency than traditional FIFO interfaces.

What is claimed is:

1. An interface for facilitating communication of data between a source block and a sink block, comprising:
a first register element that receives data from said source block via an input line, wherein said first register element changes value when a clock enable signal is applied to said first register element and maintains its value when said clock enable signal is not applied;
a first multiplexer coupled to said input line and an output of said first register element; and
a first shift register for receiving a signal from said sink block indicating that said sink block is retrieving data from said interface;
wherein said first shift register outputs a delayed version of said signal from said sink block to provide said clock enable signal to said first register element and to control an output of said first multiplexer.

2. The interface of claim 1 wherein said register element comprises:
a second multiplexer; and
a second shift register receiving an output from said second multiplexer, wherein said second multiplexer multiplexes between an output of said second shift register and said input line.

3. The interface of claim 1 further comprising:
a second register element and a third register element disposed between said first register element and said source block, wherein said second and third register elements change values when a clock enable signal is applied and maintain their values when said clock enable signal is not applied.

4. The interface of claim 3 further comprising:
a fourth register element for receiving an output of said first multiplexer.

5. The interface of claim 1 wherein said first shift register provides a signal indicating that data is being retrieved from said source block by said interface.

6. A method of operating an interface between a source block and a sink block, comprising:
receiving signals from said sink block indicating that said sink block is retrieving data from said interface;
delaying said signals by a first shift register;
applying delayed versions of said signals as clock enable signals to a first register element to load said first register element with respective data values from said source block; and
applying delayed versions of said signals to a first multiplexer to control output values communicated toward said sink block, wherein one input of said first multiplexer is coupled to said first register element.

7. The method of claim 6 further comprising:
communicating delayed versions of said signals to said source block to indicate retrieval of data from said source block by said interface.

8. The method of claim 6 further comprising:
buffering an output of said multiplexer by a second register element, wherein said second register element receives said signals as clock enable signals.

9. The method of claim 6 wherein another input of said multiplexer is coupled to a data line from said source block.

10. The method of claim 6 wherein said first register element comprises a second shift register receiving an output from a second multiplexer, said second multiplexer having a first input coupled to an output of said second shift register and a second input coupled to an input line, wherein an output of said second multiplexer is controlled by delayed versions of said signals.

11. An interface for facilitating communication of data from a source block to a sink block, comprising:
a plurality of register elements for receiving data elements from said source block, wherein said plurality of register elements maintain values when a clock enable signal is not applied and change their values when said clock enable signal is applied;
a multiplexer coupled to at least a subset of said plurality of register elements, said multiplexer communicating output data values toward said sink block; and
control logic for controlling said multiplexer using a history of assertions of signals from said sink block associated with retrieval of data from said interface by said sink block.

12. The interface of claim 11 further comprising:
a plurality of shift registers for receiving signals associated with retrieval of data from said interface by said sink block, wherein said history of assertions is provided to said control logic by said plurality of shift registers.

13. The interface of claim 11 further comprising:
a plurality of shift registers for buffering assertions, of signals from said sink block associated with retrieval of data from said interface, before communication of said assertions to said source block to indicate retrieval of data from said source block by said interface.

14. The interface of claim 11 further comprising:
at least one shift register for receiving data elements from said source block before said data elements are communicated to said plurality of register elements.

15. The interface of claim 11 further comprising:
at least one shift-register for receiving data elements from said multiplexer before said data elements are communicated to said sink block.

16. The interface of claim 11 wherein said control logic is a look-up table.

17. The interface of claim 11 wherein said control logic calculates a number of assertions, of signals from said sink block associated with retrieval of data, within a predetermined number of clock cycles.

18. The interface of claim 17 wherein said control logic is operable to increment, decrement, and maintain a stored count that is indicative of a number of instances of valid data stored in said interface.

19. The interface of claim 11 further comprising:
a shift register for communicating a signal from said interface to said sink block indicating that said interface is ready to communicate data to said sink block.

20. The interface of claim 11 further comprising:
a plurality of shift registers for buffering signals from said source block indicating that said source block is ready to communicate data.

21. The interface of claim 20 further comprising:
another multiplexer, coupled to said plurality of shift registers, that provides a signal indicating that said interface is ready to communicate data to said sink block.

22. The interface of claim 21 wherein said plurality of register elements receive said clock enable signal in response to said sink block communicating a signal associated with retrieval of data from said interface by said sink block.
